(19) United States
(12) Patent Application Publication
(10) Pub. No.: US 2006/0033753 A1
(43) Pub. Date: Feb. 16, 2006

(54) Apparatuses and methods for incorporating an overlay within an image

(76) Inventor: Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/918,723

(22) Filed: Aug. 13, 2004

(51) Int. Cl. G09G 5/00

(52) U.S. Cl. 345/629

(57) ABSTRACT

A hardware implemented method for incorporating an overlay within an image is provided. In this hardware implemented method, the image from an image capture device is received along a non-memory communication path and the overlay is read from a memory. The image and the overlay are then combined to generate a combined image. Display controllers and an apparatus for incorporating the overlay within the image also are described.

### CROSS REFERENCE TO RELATED APPLICATIONS

This application is related to U.S. application Ser. No. 10/776,357, filed on Feb. 11, 2004, and entitled “Apparatus and Method to Connect an External Camera to an LCD Without Requiring a Display Buffer.” The disclosure of this application, is incorporated herein by reference in its entirety for all purposes.

This application is related to U.S. Patent Publication No. 2002/0057265, filed on Oct. 23, 2001, and entitled “Display Driver, and Display Unit and Electronic Instrument Using the Same.” The disclosure of this application, is incorporated herein by reference in its entirety for all purposes.

This application is related to U.S. Patent Publication No. 2002/0018058, filed on Jul. 25, 2001, and entitled “RAM-Incorporated Driver, and Display Unit and Electronic Equipment Using the Same.” The disclosure of this application, is incorporated herein by reference in its entirety for all purposes.

### BACKGROUND OF THE INVENTION

1. Field of the Invention

This invention relates generally to computer graphics and, more particularly, to methods and apparatuses for incorporating an overlay within an image.

2. Description of the Related Art

Many portable computing devices now include cameras. With cameras, these portable computing devices can capture photographic images in digital form such that the photographic images may be viewed on a liquid crystal display (LCD) and stored for later retrieval. Additionally, many of these portable computing devices can add overlays (e.g., a picture frame), which are typically stored in memory, to the photographic images.

In a conventional display controller, a photographic image received from a camera is first stored in a display buffer. Thereafter, an LCD interface reads the overlay stored in the display buffer and the photographic image for output to the LCD. The LCD interface then sends the photographic image combined with the overlay to a line buffer for storage. A Joint Photographic Experts Group (JPEG) core then compresses the combined image and outputs the compressed combined image to a host.

As a result, to incorporate an overlay within a photographic image for output to a host, the conventional display controller writes to memory twice (writes the photographic image to the display buffer once and writes the combined image to the line buffer once) and reads from the memory three times (reads photographic image from the display buffer once, reads overlay from the display buffer once, and reads combined image from the line buffer once). As such, the conventional display controller requires a total of five reads/writes to incorporate the overlay within the photographic image. Since portable computing devices typically have limited power, memory, and computing capability because of their small size and portable nature, the numerous memory reads/writes slow down the processing and encoding of photographic images with overlays.

In view of the foregoing, there is a need to reduce the number of memory reads/writes in the incorporation of the overlay within the photographic image.

### SUMMARY OF THE INVENTION

Broadly speaking, the present invention fills these needs by providing hardware implemented methods and an apparatus for incorporating an overlay within an image. It should be appreciated that the present invention can be implemented in numerous ways, including as a method, a system, or a device. Several inventive embodiments of the present invention are described below.

In accordance with a first aspect of the present invention, a hardware implemented method for incorporating an overlay within an image is provided. In this hardware implemented method, the image from an image capture device is received along a non-memory communication path, whereby the image is comprised of one or more image pixels. The overlay is then read from a memory, whereby the overlay also is comprised of one or more overlay pixels. Subsequently, the image and the overlay are combined to generate a combined image.

In accordance with a second aspect of the present invention, a hardware implemented method for incorporating an overlay within an image is provided. In this hardware implemented method, the image is read from a line buffer in a first read. At the same time, the overlay is read from a memory in a second read. The image and the overlay from the first and second reads are combined to generate a combined image, and the combined image is then encoded to produce a compressed combined image for output to a host.

In accordance with a third aspect of the present invention, a display controller for incorporating an overlay within an image is provided. The display controller includes a memory, whereby the memory includes a first memory block configured to store the overlay, which is comprised of one or more overlay pixels. The display controller also includes selection circuitry in communication with the first memory block, a display panel, and an image capture device. The selection circuitry is configured to output an image pixel received from the image capture device or the overlay pixel read from the first memory block to the display panel.

In accordance with a fourth aspect of the present invention, an apparatus for incorporating an overlay within an image is provided. The apparatus includes a display controller. The display controller includes circuitry for receiving the image from the image capture device without accessing a memory, circuitry for reading the overlay from the memory, and circuitry for combining the image and the overlay to generate a combined image. The display controller further includes a central processing unit (CPU) in communication with the display controller, a display panel in communication with the display controller for displaying the combined image, and an image capture device in communication with the display controller.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a flowchart diagram of a high level overview of a hardware implemented method for incorporating an overlay within an image, in accordance with one embodiment of the present invention.

FIG. 2 is a more detailed flowchart diagram of a hardware implemented method so for incorporating an overlay within an image, in accordance with one embodiment of the present invention.

FIG. 3 is a simplified block diagram of the incorporation of an overlay within an image, in accordance with one embodiment of the present invention.

FIG. 4 is a simplified schematic diagram of an apparatus for incorporating an overlay within an image, in accordance with one embodiment of the present invention.

FIG. 5 is a more detailed schematic diagram of the display controller shown in FIG. 4, in accordance with one embodiment of the present invention.

FIG. 6 is another detailed schematic diagram of the display controller shown in FIG. 4, in accordance with one embodiment of the present invention.

### DETAILED DESCRIPTION OF THE PREFERRED EMBODIMENTS

An invention is described for hardware implemented methods and apparatuses for incorporating an overlay within an image. It will be obvious, however, to one skilled in the art, that the present invention may be practiced without some or all of these specific details. In other instances, well known process operations have not been described in detail in order not to unnecessarily obscure the present invention.

The embodiments described herein provide an apparatus, display controllers, and hardware implemented methods for incorporating an overlay within an image. In one embodiment, an image is received from an image capture device along a non-memory communication path. As will be explained in more detail below, the non-memory communication path is a communication path that bypasses reading of the image from a memory. At the same time, the overlay is read from the memory, and the image and the overlay are combined to generate a combined image. The combined image may either be viewed on a display panel or captured for output to a host.

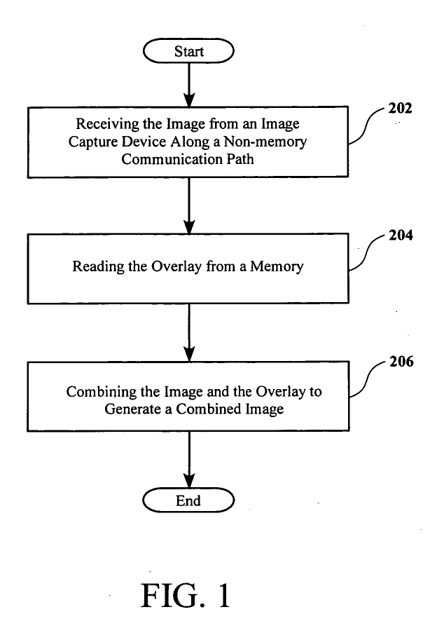

FIG. 1 is a flowchart diagram of a high level overview of a hardware implemented method for incorporating an overlay within an image, in accordance with one embodiment of the present invention. Starting in operation 202, the image from an image capture device is received along a non-memory communication path. The non-memory communication path is a communication path that bypasses writing the image into memory and then reading of the image from the memory. In other words, the image is directly received from the image capture device without accessing the memory. Subsequently, in operation 204, the overlay is read from the memory, and the image and the overlay are combined in operation 206 to generate a combined image for display or compression. It should be noted that the terms “compress” and “encode” may be used interchangeably.

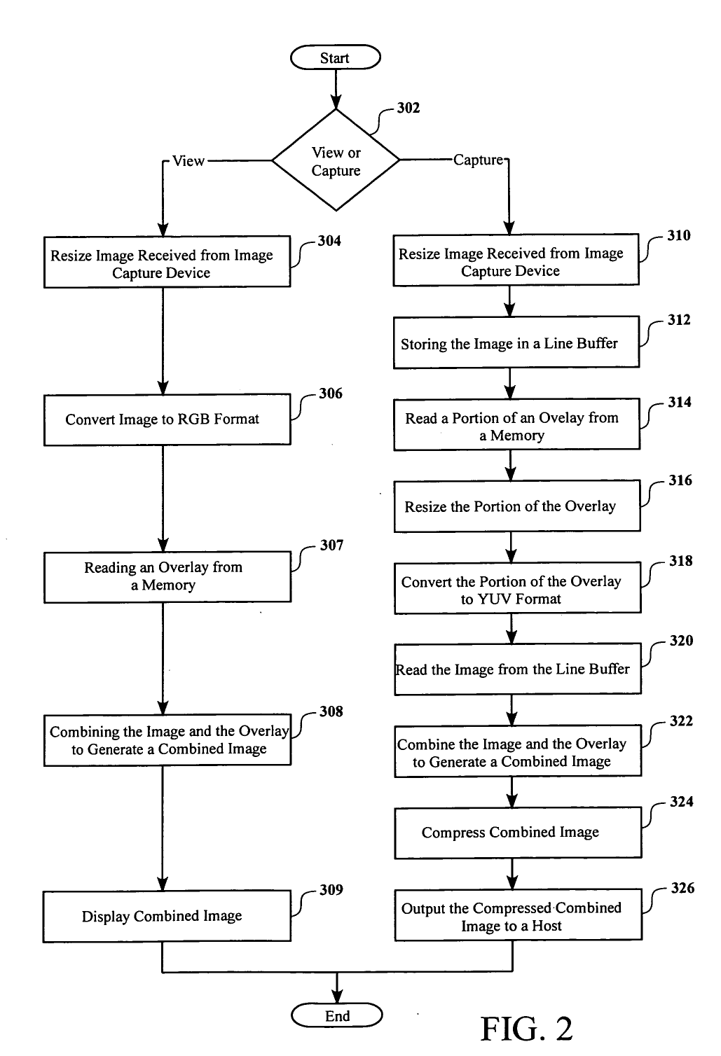

FIG. 2 is a more detailed flowchart diagram of a hardware implemented method for incorporating an overlay within an image, in accordance with one embodiment of the present invention. Starting in operation 302, a user may select to view a combined image (i.e., image with overlay) or capture the combined image for transmission to a host. If the user selects to view the combined image, the image received from an image capture device is first resized to match the appropriate size of a display panel in operation 304, in accordance with one embodiment of the present invention. Subsequently, in one embodiment, the image is converted to red, green, blue (RGB) format in operation 306. The overlay that is stored in memory is then read from the memory in operation 307. As will be described in more detail below, the image received from the image capture device and the overlay read from the memory are then combined to generate the combined image in operation 308. Thereafter, in operation 309, the combined image is displayed on a display panel. As such, unlike the overlay, the image is not stored in the memory but is directly received from the image capture device.

As an alternative to viewing the image, the user may select to capture the combined image to a host in operation 302. Here, in one embodiment, the image received from the image capture device is first resized to a size defined by the user in operation 310. Thereafter, in operation 312, the image is stored in a line buffer. The overlay is then read from memory in operation 314. In one embodiment, the overlay is resized in operation 316 to match the size of the image defined by the user and the overlay is subsequently converted to Y, Cb, and Cr (YUV) format in operation 318. Afterwards, the image is read from the line buffer in operation 320 and the image and the overlay are combined to generate a combined image in operation 322. The combined image is then encoded in operation 324 and output to a host in operation 326.

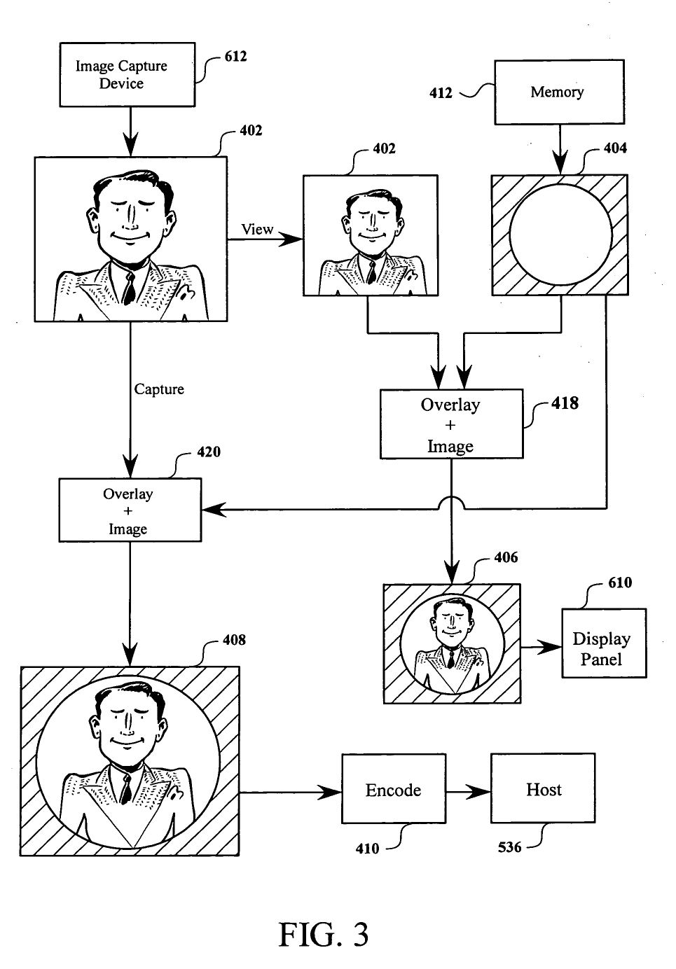

FIG. 3 is a simplified block diagram of the incorporation of an overlay within an image, in accordance with one embodiment of the present invention. Image 402 received from image capture device 612 includes a picture of a person. Here, overlay 404 stored in memory 412 is a square frame. Image 402 may be displayed on display panel 610 or captured for output to host 536. If image 402 is to be displayed, the image received from image capture device 612 and overlay 404 read from memory 412 are combined at module 418 to generate first combined image 406 for output to display panel 610. As shown in FIG. 3, first combined image 406 includes the picture of the person surrounded by the frame.

However, if image 402 is to be captured for output to host 536, then the image is combined with overlay 404 at module 420 to generate second combined image 408. Second combined image 408 is subsequently encoded in module 410 for output to host 536. As will be explained in more detail below, because viewing image 402 and capturing the image are independent, the sizes of first combined image 406 and second combined image 408 may be different.

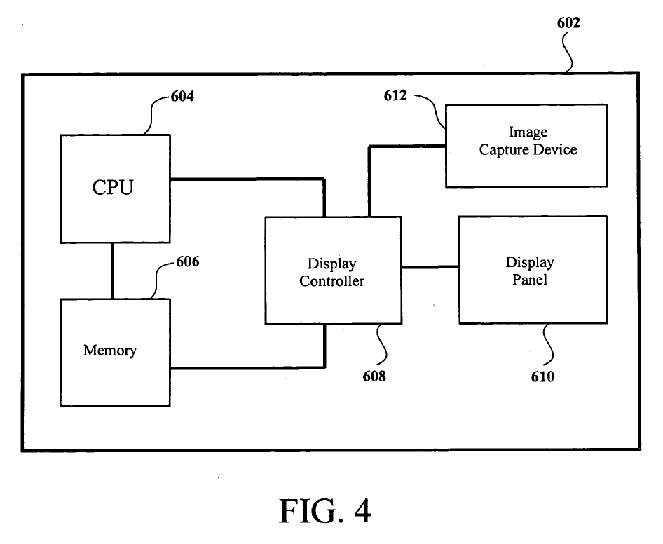

FIG. 4 is a simplified schematic diagram of an apparatus for incorporating an overlay within an image, in accordance with one embodiment of the present invention. Apparatus 602 includes any suitable type of computing device. For example, apparatus 602 may be a personal digital assistant, a cell phone, a web tablet, a pocket personal computer, etc. As shown in FIG. 4, apparatus 602 includes central processing unit (CPU) 604, memory 606, display controller 608, display panel 610, and image capture device 612. Display controller 608 is in communication with CPU 604, memory 606, image capture device 612, and display panel 610. One skilled in the art will appreciate that while CPU 604, memory 606, display controller 608, image capture device 612, and display panel 610 are illustrated as being interconnected, each of these components may be in communication through a common bus.

Image capture device 612 records photographic images as image data and outputs the image data to display controller 608. It should be appreciated that image capture device 612 may include a charge-coupled device to capture the image. Examples of image capture device 612 include cameras, digital cameras, video cameras, digital video cameras, etc.

Examples of memory 606 include any suitable memory types, such as static access memory (SRAM), dynamic random access memory (DRAM), etc. In one embodiment, the overlay is stored in a memory included within display controller 608. In another embodiment, memory 606, which is external to display controller 608, may also be configured to store the overlay.

Display panel 610 may include RAM-integrated display panels, liquid crystal displays (LCD), thin-film transistor (TFT) displays, cathode ray tube (CRT) monitors, televisions, etc. One skilled in the art will appreciate that RAM-integrated display panels include integrated chip display drivers with built-in random access memory (RAM) that drives a display section based on still-display data and moving-display data. In effect, the combined image may be temporarily stored in the built-in RAM. For more information on RAM-integrated panels, reference may be made to U.S. patent publication No. 2002/0057265, entitled “Display Driver, and Display Unit and Electronic Instrument Using the Same,” and to U.S. patent publication No. 2002/0018058, entitled “RAM-Incorporated Driver, and Display Unit and Electronic Equipment Using the Same,” and which are herein incorporated by reference.

The functionality described above for incorporating an overlay within an image is incorporated into display controller 608. In one embodiment, display controller 608 includes circuitry for receiving the image from image capture device 612. The communication path within image capture device 612 for displaying the captured image does not include a memory. That is, the image to be displayed bypasses the internal memory of display controller 608. Display controller 608 also includes circuitry for reading the overlay from a memory, either from memory 606 or from a memory located within display controller 608. Circuitry for combining the image and the overlay to generate a combined image is also included within display controller 608.

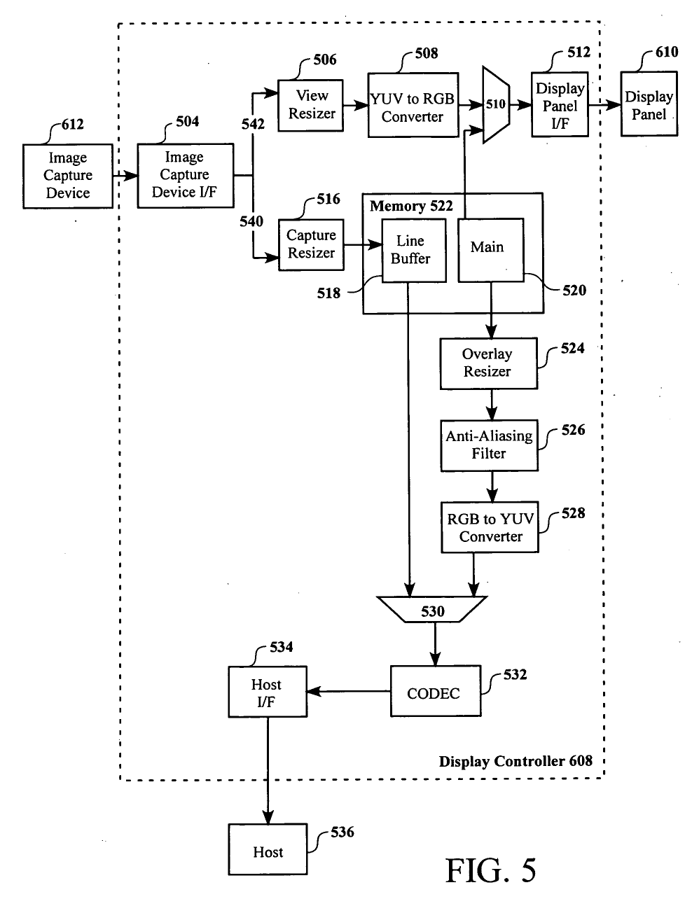

FIG. 5 is a more detailed schematic diagram of display controller 608 shown in FIG. 4, in accordance with one embodiment of the present invention. As shown in FIG. 5, depending on whether the user selects to view or capture the image from image capture device 612, the image may be sent along view communication path 542 or along capture communication path 540, respectively. In one embodiment, view communication path 542 includes view resizer 506, YUV to RGB converter 508, selection circuitry 510 (e.g. a multiplexer), and display panel interface 512. If the user selects to view the image, image capture device interface 504 first sends the image received from image capture device 612 to view resizer 506 along view communication path 542. View resizer 506 resizes the image to the appropriate size of display panel 610. For example, image capture device 612 captures images in 640×640 pixel resolution. In contrast, display panel 610 may have a 160×160 pixel resolution. To fit the image within display panel 610, view resizer 506 shrinks the 640×640 pixel image received from image capture device 612 to a 160×160 pixel resolution. View resizer 506 is optional and may be excluded if the size of the image received from image capture device 612 is the same as the size of display panel 610.

Subsequently, YUV to RGB converter 508 converts the image, which is in YUV format, to the appropriate RGB format suitable for display panel 610. YUV to RGB converter 508 is also optional and may be excluded if display panel 610 accepts data in YUV format. Selection circuitry 510 receives the image from YUV to RGB converter 508 and reads an overlay from memory 522. Memory 522 includes any suitable type of memory such as SRAM, DRAM, etc. and, in one embodiment, the memory is divided into separate line buffer 518 and main memory 520 blocks. As will be explained in more detail below, line buffer 518 stores a portion of the image and main memory block 520 stores the overlay.

Selection circuitry 510 then combines the image received from image capture device 612 and overlay read from main memory block 520 to generate a combined image for output to display panel interface 512. It should be appreciated that, in one embodiment, display panel interface 512 may include a pixel counter and a line counter that track the pixels being output for display. From these two counters, display panel interface 512 can fetch the appropriate overlay pixels from main memory block 520 for display. In one embodiment, selection circuitry 510 also includes logic for generating the combined image. Specifically, the overlay may be comprised of transparent parts and solid parts. When the overlay is incorporated with the image, the image is visible on parts of the overlay that are transparent. The transparent parts are comprised of pixels that are transparent. As is known to those skilled in the art, each pixel is defined by a number of bits (e.g., eight bits, sixteen bits, etc.), and the bits define whether the pixel is transparent. For example, a transparency register has a particular eight bit value. If an eight bit value of a pixel matches the transparency register, then the pixel is transparent.

In one embodiment, selection circuitry 510 generates the combined image by first analyzing each overlay pixel read from main memory block 520 to determine whether the overlay pixel is transparent. If the overlay pixel is not transparent, then selection circuitry 510 selects the overlay pixel for display. However, if the overlay pixel is transparent, then selection circuitry 510 selects the image pixel for display instead. The above described process of selecting the overlay pixel or the image pixel for display depending on whether the overlay pixel is transparent gives the impression that the overlay is placed on top of the image, thereby generating a combined image.

The above-described method of directly displaying the image from image capture device 612 without accessing memory 522 may be done on RAM-integrated panels by synchronizing the clocks of image capture device interface 504, view resizer 506, and YUV to RGB converter 508. For more information on displaying the image without accessing memory 522, reference may be made to U.S. patent application Ser. No. 10/776,357, entitled “Apparatus and Method to Connect an External Camera to an LCD Without Requiring a Display Buffer,” which is herein incorporated by reference. The above-described architecture may also work on non RAM-integrated panels by synchronizing the frame rates of image capture device 612 and display panel 610.

As shown in FIG. 5, image from image capture device 612 may also be sent to codec 532 for compression along capture communication path 540. In one embodiment, capture communication path 540 includes capture resizer 516, line buffer 518, combination circuitry 530, codec 532, overlay resizer 524, anti-aliasing filter 526, RGB to YUV converter 528, and host interface 534. If the user selects to capture the image, image capture device interface 504 first sends the image received from image capture device 612 to capture resizer 516 along capture communication path 540. Capture resizer 516 resizes the image to a size defined by the user. Since view communication path 542 is independent from capture communication path 540, the size of the captured image may be different from a size of the image sent for display on display panel 610. In other words, the user may select to capture the image in a different size than the size of display panel 610. In effect, the captured image size is not limited by the size of display panel 610 and therefore, the user may capture the image in a higher or lower resolution than the image displayed on display panel 610.

Subsequently, the image is sent to line buffer 518 for temporary storage. Line buffer 518 is configured to store a portion of the image received from image capture device 612. One skilled in the art will appreciate that some codecs require a line buffer because these codecs cannot encode lines of image data but encode blocks of image data instead. For example, a JPEG codec is configured to encode a block that consists of eight lines of image data with eight pixels per line.

At the same time the image is being sent to combination circuitry 530, the overlay is read from main memory block 520. In one embodiment, overlay resizer 524 resizes the overlay to match the size of the image. In another embodiment, anti-aliasing filter 526 may be included to smooth lines within the overlay after overlay resizer 524 resizes the overlay. Alternatively, in yet another embodiment, overly resizer 524 may include the logic for smoothing the overlay. RGB to YUV converter 528 is also included to convert the overlay from RGB to YUV format. However, RGB to YUV converter 528 is optional and, in one embodiment, may be excluded depending on the type of input format required by codec 532.

Combination circuitry 530 then combines the image from line buffer 518 and the overlay from main memory block 520 to generate a combined image. It should be appreciated that to generate combined image, codec 532 may include a pixel counter and a line counter that track the pixels being encoded for display, in accordance with one embodiment of the present invention. From these two counters, codec 532 can fetch the appropriate overlay pixels from main memory block 520. Codec 532 then compresses the combined image and outputs the compressed combined image to a host 536 (e.g., CPU, hard disk drive, optical disk drive, etc.) through host interface 534.

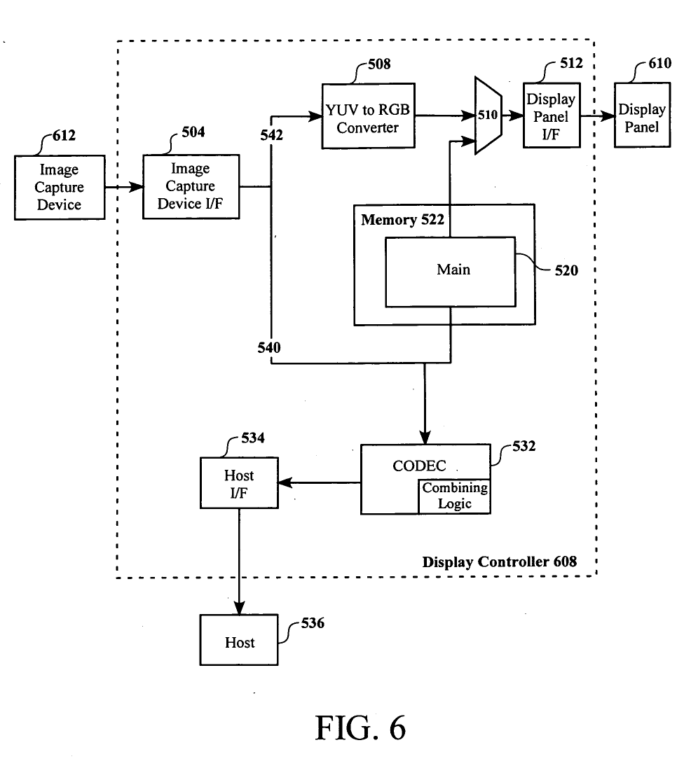

FIG. 6 is an alternative detailed schematic diagram of display controller 608 shown in FIG. 4, in accordance with one embodiment of the present invention. Depending on whether the user selects to view the image or capture the image, the image received from image capture device 612 may also be sent along view communication path 542 or along capture communication path 540, respectively. In this embodiment, view communication path includes YUV to RGB converter 508, selection circuitry 510, and display panel interface 512. When the image is viewed, the processing of the image from image capture device 612 and overlay read from main memory block 520 is the same as the process discussed in FIG. 5 with the exception that the image is not resized. A view resizer is not included in this embodiment because, as discussed above, the view resizer is optional and may be excluded if the size of the image received from image capture device 612 is the same as the size of display panel 610.

On the other hand, capture communication path 540 includes codec 532 and host interface 534. The overlay is also stored in memory 522 but, in this embodiment, instead of being divided into two memory blocks, memory 522 includes one main memory block 520 to store the overlay. A line buffer is not included in this embodiment because, as discussed above, some codecs can encode lines of image data and do not require a line buffer.

Additionally, an overlay resizer, an anti-aliasing filter, an RGB to YUV converter, and a combination circuitry are not included in this embodiment. The overlay resizer is optional as the size of the image received from image capture device 612 may be the same as the size of the overlay. The lines within the overlay do not need to be smoothed and, as such, the anti-aliasing filter is optional. As discussed above, some codecs can processes data in RGB format and, as a result, an RGB to YUV converter is also optional. Finally, a combination circuitry is not included in this embodiment because, as shown in FIG. 6, the logic for combining the image from image capture device 612 and the overlay from main memory block 520 may instead be incorporated in codec 532.

In summary, the above-described invention provides hardware implemented methods and apparatuses for incorporating an overlay within an image. Essentially, to reduce the number of memory reads/writes, the image received from an image capture device is not temporarily stored in memory before being sent to a display panel for display. When compared to a conventional display controller, bypassing the memory reduces the number of memory reads/writes. For example, to capture the image with overlay for output to a host, an embodiment of the present invention requires only three memory reads/writes (write image to line buffer once, read image from line buffer once, and read overlay from main memory block once). In contrast, the conventional display controller requires a total of five memory reads/writes to capture the image with overlay for output to a host. As should be appreciated, the reduction in memory accesses reduces power consumption. Furthermore, memory space is reduced by not storing the image in main memory block. As a result, the reduction of memory space and the reduction of memory reads/writes save processing power and bandwidth. Thus, small, portable devices with limited power, memory, and computing capability incorporating the above-described invention can adequately process and incorporate overlays within images.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for incorporating an overlay within an image, comprising method operations of:
receiving the image from an image capture device along a non-memory communication path, the image being comprised of one or more image pixels;
reading the overlay from a memory, the overlay being comprised of one or more overlay pixels; and
combining the image and the overlay to generate a combined image.

2. The hardware implemented method of claim 1, wherein the method operation of combining the image and the overlay to generate the combined image includes,
selecting the image pixel for display if the overlay pixel is transparent; and
selecting the overlay pixel for display if the overlay pixel is not transparent.

3. The hardware implemented method of claim 1, further comprising:
displaying the combined image on a display panel.

4. The hardware implemented method of claim 1, further comprising:
encoding the combined image to produce a compressed combined image for output to a host.

5. The hardware implemented method of claim 4, wherein the compressed combined image is selected from the group consisting of a Joint Photographic Experts Group (JPEG) image, a Graphic Interchange Format (GIF) image, and a Portable Network Graphics (PNG) image.

6. The hardware implemented method of claim 1, wherein the method operation of receiving the image from the image capture device along the non-memory communication path includes,
receiving the image from the image capture device without accessing the memory.

7. The hardware implemented method of claim 1, wherein the non-memory communication path is a communication path that bypasses reading of the image from the memory.

8. The hardware implemented method of claim 1, wherein the image is not stored in the memory.

9. A hardware implemented method for incorporating an overlay within an image, comprising method operations of:
reading the image from a line buffer in a first read;
reading the overlay from a memory in a second read;
combining the image and the overlay from the first and second reads to generate a combined image; and
encoding the combined image to produce a compressed combined image for output to a host.

10. The hardware implemented method of claim 9, further comprising:
resizing the overlay to match a size of the image; and
converting the overlay to Y, Cb, and Cr (YUV) format.

11. The hardware implemented method of claim 9, wherein the line buffer is configured to store a portion of the image.

12. A display controller for incorporating an overlay within an image, comprising:
a memory including a first memory block configured to store the overlay, the overlay being comprised of one or more overlay pixels; and
a selection circuitry in communication with the first memory block, a display panel, and an image capture device, the selection circuitry being configured to output an image pixel received from the image capture device or the overlay pixel read from the first memory block to the display panel.

13. The display controller of claim 12, further comprising:
a codec in communication with the first memory block and the image capture device, the codec including logic for combining the image received from the image capture device and the overlay read from the first memory block to generate a combined image.

14. The display controller of claim 13, wherein the memory further includes,
a second memory block in communication with the codec and the image capture device, the second memory block being configured to store a portion of the image received from the image capture device.

15. The display controller of claim 14, wherein the second memory block is a line buffer.

16. The display controller of claim 13, wherein the codec is selected from the group consisting of a Joint Photographic Experts Group (JPEG) codec, a Graphics Interchange Format (GIF) codec, and a Portable Network Graphics (PNG) codec.

17. The display controller of claim 12, wherein the memory is selected from the group consisting of a static random access memory (SRAM) and a dynamic random access memory (DRAM).

18. An apparatus for incorporating an overlay within an image, comprising:
a display controller including,
circuitry for receiving the image from the image capture device without accessing a memory, the image being comprised of one or more image pixels,
circuitry for reading the overlay from the memory, the overlay being comprised of one or more overlay pixels, and
circuitry for combining the image and the overlay to generate a combined image;
a central processing unit (CPU) in communication with the display controller;
a display panel in communication with the display controller for displaying the combined image; and
an image capture device in communication with the display controller.

19. The apparatus of claim 18, wherein the display controller further includes,
circuitry for encoding the combined image to produce a compressed combined image for output to the CPU.

20. The apparatus of claim 18, wherein the display panel is selected from the group consisting of a random access memory (RAM) integrated display, a liquid crystal display (LCD), a thin-film transistor (TFT) display, a cathode ray tube (CRT) monitor, and a television.

21. The apparatus of claim 18, wherein the image is not stored in the memory.
